(19) United States
(12) Patent Application Publication
(10) Pub. No.: US 2006/0282261 A1
(43) Pub. Date: Dec. 14, 2006

(54) Sample rate control in pitching audio systems

(76) Inventor: Andrej Petef, Malmo (SE)

Correspondence Address: COATS & BENNETT, PLLC, P O BOX 5, RALEIGH, NC, 27602, US

(21) Appl. No.: 11/241,422

(22) Filed: Sep. 30, 2005

Related U.S. Application Data
(60) Provisional application No. 60/689,826, filed on Jun. 13, 2005.
(60) Provisional application No. 60/690,417, filed on Jun. 14, 2005.

(51) Int. Cl. G10L 11/04

(52) U.S. Cl. 704/207

(57) ABSTRACT

Processing load in a pitching audio processing device is controlled by varying the sample rate of one or more audio signals at predetermined intervals of pitching to maintain the lowest possible sample rate without loss of audio content. When an overload condition is detected, an early downward change or late upward change in sample rate may be forced to reduce processing load with some loss of audio content. A forced rate change may be applied only to selected audio signal, or to all audio signals being processed.

### RELATED APPLICATIONS

This application claims priority to Provisional U.S. Patent Application 60/689,826 filed on Jun. 13, 2005 and to Provisional U.S. Patent Application 60/690,417 filed on Jun. 14, 2005, which are incorporated herein by reference.

### BACKGROUND

The present invention relates generally to digital audio devices and, more particularly, to a method and apparatus for controlling processing load in a pitching audio device.

Pitch-shifting or pitch transposition is a technique for changing the pitch of an audio signal. Pitch may be described as the perceived frequency of a note. Changing the pitch up or down will be perceived as playing back the audio at a higher or lower frequency. Changing the pitch of an audio signal will also contract or expand the spectral content of the signal.

Pitch-shifting is a normal function of many audio processing systems. For example, in a karaoke system, pitch-shifting is used to adjust the pitch of the music to suit the person singing along to the music. In audio effects processing, pitch-shifting is used to create special audio effects, such as the Doppler Effect. In a wavetable synthesizer, pitch-shifting is required to create notes from a stored waveform.

Pitch-shifting is typically performed in a digital signal processor (DSP) that executes an interpolation algorithm. In devices with limited memory, fewer samples can be stored in memory and the interpolation algorithm may be computationally complex. For example, a wave table synthesizer for 128 voice polyphony would require the interpolation algorithm to be simultaneously executed on 128 synthesizer voices. The computational complexity is proportional to the sample rate. A higher sample rate implies more samples to be processed, while a lower sample rate implies fewer samples to process. In situations where central processing unit (CPU) resources are limited, pitch-shifting algorithms may consume a significant portion of those CPU resources. For example, a wavetable synthesizer may be used in mobile handheld devices to generate ring tones or other audible sounds. Such devices typically have limited CPU resources available for audio processing. It is desirable, therefore, to find ways to reduce demands on CPU resources while still maintaining high quality audio.

### SUMMARY

The present invention relates to a method and apparatus for changing the pitch of an audio signal. A control module receives a pitch parameter and directs a pitch-shifting module to change its playback rate depending on the pitch parameter. In one embodiment, the playback rate is changed at octave intervals of the pitch parameter and the pitch parameter is adjusted by a corresponding amount to account for the change in the playback rate. Reducing the playback rate of the audio signal at octave intervals of the pitch parameter reduces the computational load on the processor without loss of audio content. When the processing load becomes excessive, the control module can force an early change or late change in the sample rate responsive to the current processing load to reduce the processing load. The forced rate change can be implemented in a manner to maintain a high signal quality despite some loss in bandwidth.

### BRIEF DESCRIPTION OF THE DRAWINGS

FIG. 1 is a functional block diagram of an exemplary audio processing circuit.

FIGS. 2a-2c illustrate the relationship between playback rate and frequency.

FIG. 3 is a graph illustrating an exemplary rate control method for controlling the playback rate of a signal originally sampled at 8 kHz as a function of a pitch parameter.

FIG. 4 is a graph illustrating an exemplary rate control method for controlling the playback rate of a signal originally sampled at 32 kHz as a function of a pitch parameter.

FIG. 5 is a graph illustrating an exemplary rate control method for controlling the playback rate of a signal originally sampled at 8 kHz as a function of a pitch parameter.

FIG. 6 is a flow chart illustrating exemplary control logic for a control module implementing the rate control methods illustrated in FIGS. 3-5.

### DETAILED DESCRIPTION

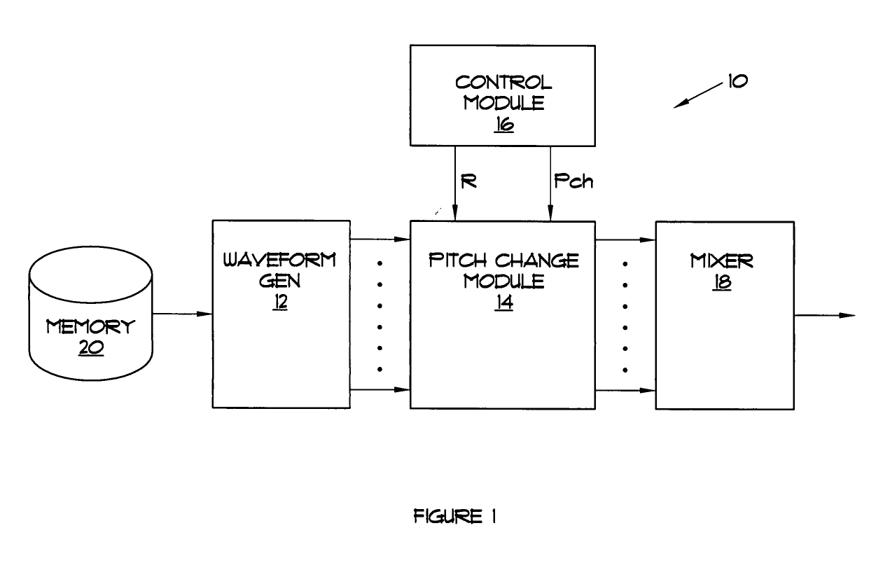

Referring now to the drawings, FIG. 1 illustrates an audio processing circuit indicated generally by the numeral 10 for adjusting the pitch of one or more audio signals. The exemplary embodiment is configured as a wavetable synthesizer. However, the audio processing circuit 10 has practical utility in a wide variety of devices including karaoke equipment and audio effects equipment. The audio processing circuit 10 comprises a waveform generator 12 or other audio source, a pitch-shifting module 14, a control module 16, and a mixer 18. The audio processing circuit 10 may be implemented using one or more processors, such as general purpose microprocessors, microcontrollers, digital signal processors, or a combination thereof.

The waveform generator 12 generates waveforms from stored waveform samples in memory 20. Memory 20 stores waveforms for a plurality of sounds or “voices,” which can be processed and combined to produce a musical composition. For example, memory 20 may store waveform samples corresponding to different instruments. The waveform generator 12 reads out samples of a stored waveform for selected sounds or synthesizer voices and generates a periodic audio signal from the stored waveform samples by repeatedly playing or looping the waveform samples. The waveform generator 12 may generate multiple simultaneous audio signals. In other embodiments, the audio source 12 may read out pulse code modulation (PCM) samples from memory or other stored audio files.

The pitch-shifting module 14 changes the pitch of the input audio signals from the waveform generator 12 responsive to control signals from the control module 16. The pitch-shifting module 14 may use any known time-domain interpolation algorithm to perform pitch-shifting. A time-domain interpolation algorithm consumes the audio samples faster or slower to change the pitch of the audio signal. This change in tempo is not a problem for a wavetable synthesizer where infinite looping of a stored waveform is used to create sounds. When applied to ordinary music files, however, the applied pitching will cause the music to be played back at an altered rate. Because the details of the interpolation algorithm are not material to the present invention and are well known to those skilled in the art, those details are omitted herein for the sake of brevity. When multiple simultaneous signals are provided, the pitch-shifting module 14 normally operates independently on each signal.

The control module 16 receives control information regarding desired pitch changes for each audio signal and generates the control signals to control the pitch-shifting module 14. More particularly, control module 16 generates a pitch parameter (Pch) and a rate parameter (R) for each input audio signal. Both of these parameters are provided to the pitch-shifting module 14. The rate parameter specifies the sample rate at which the supplied samples of the audio signal are processed and output by the pitch-shifting module 14, while the pitch parameter specifies the amount of pitch-shifting to be applied. It should be noted that the processing rate and output sample rate of the pitch-shifting module 14 are the same, but may be different than the input sample rate to the pitch-shifting module 14. In the following discussion, the processing rate and sample output rate are referred to as the playback rate.

Mixer 18 combines the output audio signals from the pitch-shifting module 14 to generate a combined audio signal. The combined audio signal may then be output to audio reproduction equipment.

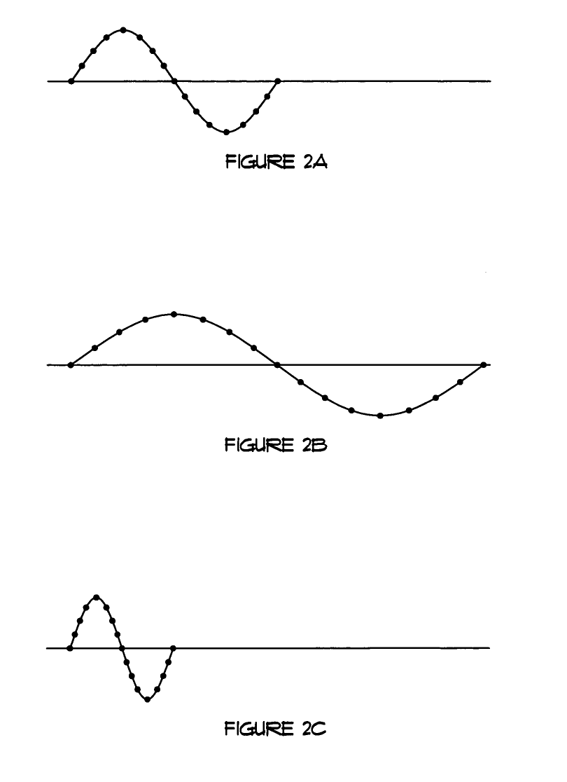

Pitch-shifting alters the spectral content of an audio signal. When an audio signal is pitched down, the signal bandwidth is reduced. Conversely, when the audio signal is pitched up, the signal bandwidth is increased. This relationship between playback rate and frequency is illustrated in FIGS. 2A-2C. FIG. 2A illustrates a sinusoid with period T sampled at the rate T/16. FIG. 2B illustrates the sinusoid generated when the same samples are played back at the rate T/8. FIG. 2C illustrates the sinusoid generated when the same samples are played back at the rate T/32. It can be seen from FIGS. 2A-2C that reducing the playback rate by one-half also reduces the frequencies contained in the audio signal by one-half. Increasing the playback rate by twice the original amount doubles the frequencies in the audio signal. Halving the playback rate is equivalent to pitch-shifting downward by one octave or −1200 cents. Doubling the playback rate is equivalent to pitch-shifting upward by one octave or +1200 cents.

The computational complexity of the interpolation algorithm used by the pitch-shifting module 14 depends on the playback rate and number of audio signals to be processed. The computational complexity increases proportionally with the playback rate and number of signals. Nyquist's sampling theorem states that the sample rate of an audio signal should be at least twice the highest frequency in a signal to prevent loss of information. Therefore, when pitching down, the playback rate may be reduced a corresponding amount without loss of audio bandwidth. When pitching up, it is necessary to increase the playback rate to avoid loss of high frequency audio content.

According to one aspect of the present invention, the demand on processing resources of the audio processing circuit 10 can be controlled by varying the playback rate as a function of a pitch parameter. During normal operation, the control module 16 maintains the playback rate as low as possible without loss of audio quality.

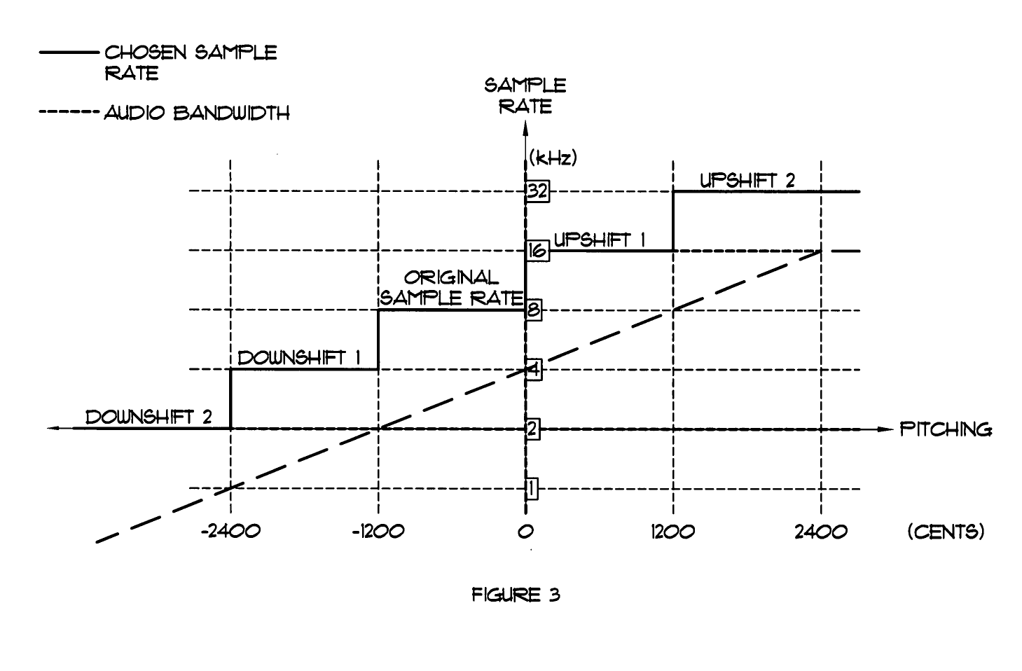

FIG. 3 illustrates a control method implemented by the control module 16 to control the playback rate in an audio processing circuit 10 to reduce processing load. In FIG. 3, the solid line represents the playback rate which changes in step-wise fashion at octave intervals of the pitch parameter, i.e., ±1200 cents. The playback rate may be adjusted independently for each audio signal. In one embodiment, the set of valid playbacks rates is constrained to 4, 8, 16 and 32 kHz for ease of conversion and mixing of audio signals. The stored waveforms in memory 20 are also sampled at one of these valid rates. The dashed line represents the audio bandwidth of the audio signal. In this example, it is assumed that the audio signal was originally sampled at a rate of 8 kHz. Therefore, according to Nyquist's theorem, the audio bandwidth of the original signal is 4 kHz. As shown in FIG. 3, pitch-shifting alters the audio bandwidth of the signal. For example, pitch-shifting the audio signal by −1200 cents reduces the audio bandwidth to 2 kHz so the playback rate can be reduced by one-half without loss of audio content. Conversely, pitch shifting upward by +1200 cents doubles the frequencies in the audio signal so the playback rate needs to be increased to prevent loss of spectral content.

As shown in FIG. 3, the control module 16 selects the lowest possible playback rate for a particular audio signal that maintains the full audio bandwidth of the audio signal. The playback rate may be adjusted independently for each audio signal. The control module 16 will vary the playback rate in step-wise fashion at octave intervals as shown in FIG. 3. As noted earlier, increasing or decreasing the playback rate by a factor of 2 is equivalent to pitch-shifting one octave or 1200 cents. Thus, the control module 16 also adjusts the pitch parameter when the playback rate is adjusted. For example, assume that the control module 16 is directed to pitch downward by −1500 cents. In this case, the control module 16 would direct the pitch-shifting module 14 to reduce the playback rate to 4 kHz and to apply a −300 pitch shift to the input signal. When pitching upward, the control module 16 directs the pitch-shifting module 14 to increase the playback rate and subtract a corresponding amount from the pitch parameter. In many audio processing systems, sample rates higher than 32 kHz may be unnecessary since 16 kHz is near the upper limits of the human threshold for hearing.

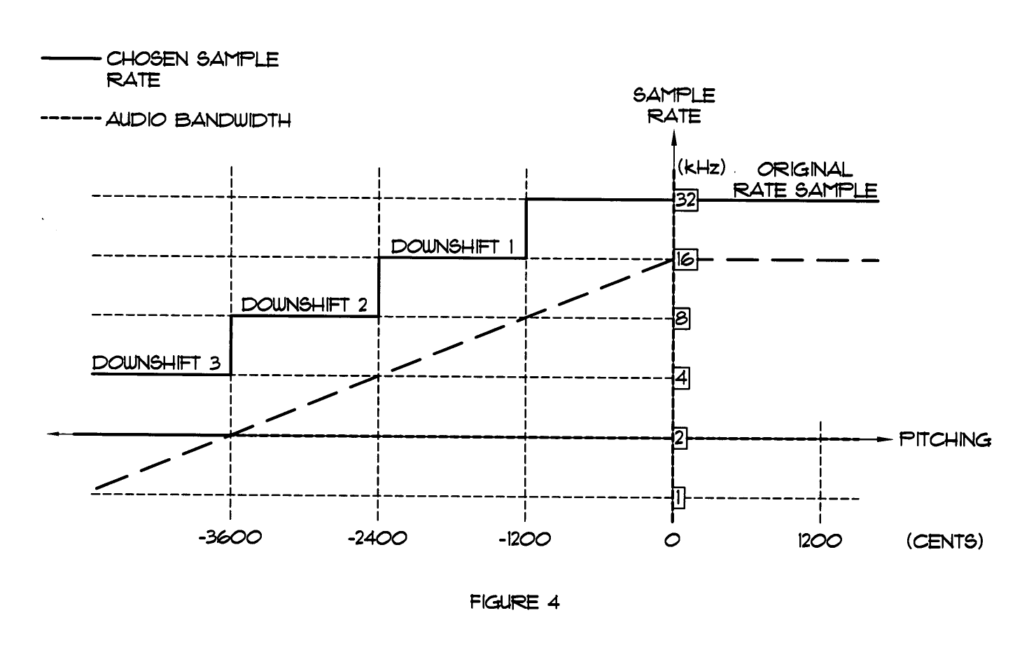

FIG. 4 illustrates the same control method applied to a signal originally sampled at 32 kHz. In this example, the sample rate is cut in half at each octave interval. Each rate change reduces the processing load by one-half. Thus, reducing the sample rate from 32 kHz to 4 kHz when pitch-shifting more than three octaves reduces processing load to one-eighth of the original load.

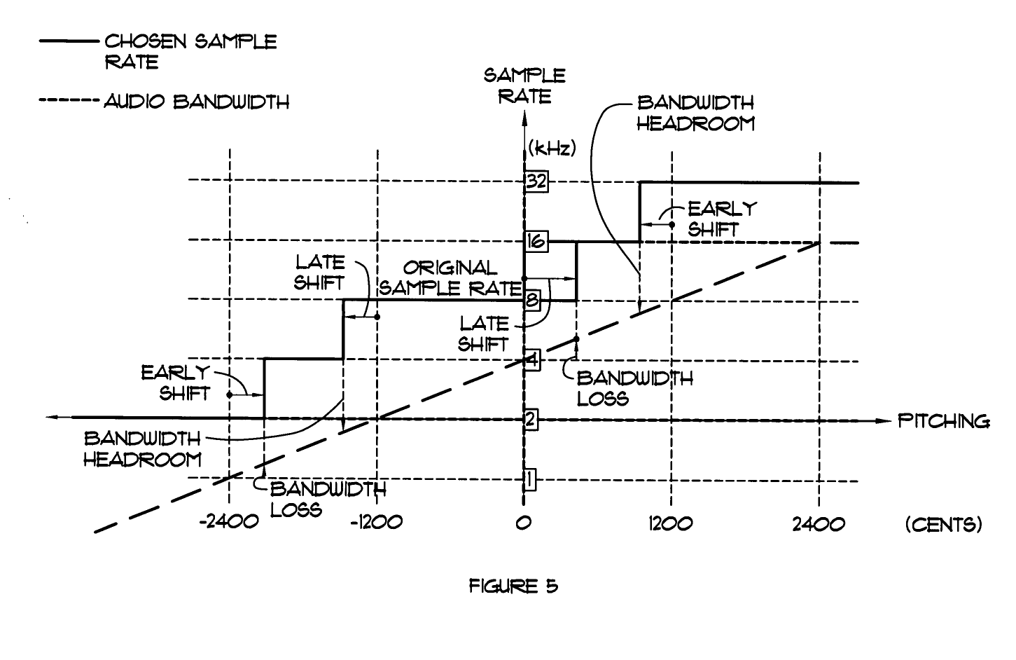

Varying the sample rate at one octave intervals reduces the computational load without loss of audio bandwidth. However, those skilled in the art will appreciate rate changes do not have to be made at exactly one octave intervals. FIG. 5 illustrates the control method where rate changes are made before/after the one octave intervals shown in FIGS. 3 and 4. A rate change made before or after the one octave interval is referred to herein as a forced rate change. A “forced” downward rate change can be made to save processing load. However, forcing an early downward rate change before a corresponding octave interval is reached, or delaying an upward rate change until after the corresponding octave interval, results in reduction of the audio bandwidth and may cause in some loss in the higher frequency content of the signal. Conversely, delaying a downward rate change or forcing an early upward rate change produces a gain in audio bandwidth. However, the bandwidth gain does not necessarily produce any practical benefit.

According to another aspect of the invention, the control module 16 can monitor processing load and direct the pitch-shifting module 14 to change the playback rate at other than normal one octave rate change intervals depending upon processing load. For example, when the processing load is high, the control module 16 may command the phase shifting module 14 to increase the playback rate at +1000 rather than +1200. Similarly, the control module 16 may command the pitch-shifting module 14 to reduce the sample rate at −1100 rather than −1200. On the other hand, if processing load is light and there is no concern about battery life, the control module may force an early upward rate change or a late downward rate change.

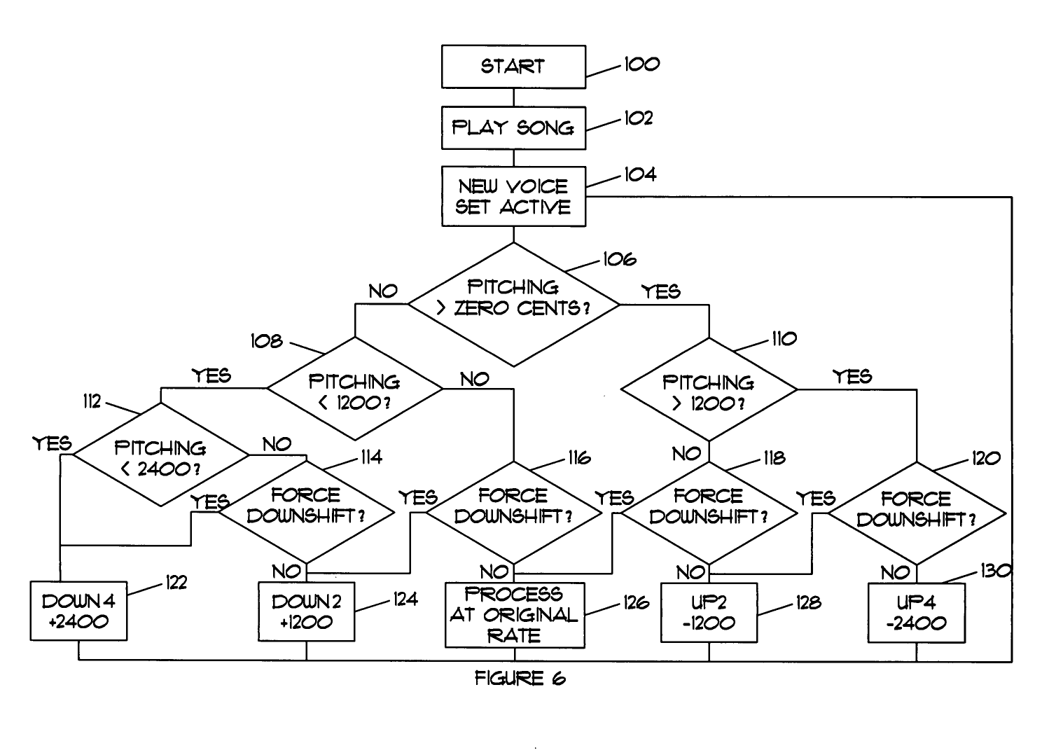

FIG. 6 illustrates an exemplary control procedure implemented by the control module 16 when audio is played. In one embodiment, the control procedure is executed each time a new audio signal or synthesizer voice is made active, which affects the processing load. The control module 16 determines the applied pitch on the new audio signal (blocks 106-112). The control module 16 further determines whether to force a rate change based on processing load (blocks 114-120). In the absence of a condition that would call for a forced change in the playback rate, the control module 16 directs the pitch shifting module 14 to reduce the playback rate by one-half when the pitch adjustment reaches −1200 cents (block 124), and requests a rate change to one-fourth of the original rate when the pitch adjustment reaches −2400 cents (block 122). Upward rate changes are requested at greater than 0 (block 128) and greater than +1200 cents (block 130). The audio signal is played back at its original sampling rate when the pitch parameter is between 0 and −1200 cents (block 126). When the playback rate is changed, the control module 16 adjusts the pitch parameter by a corresponding amount. More particularly, the pitch parameter is adjusted by ±1200 for each rate level. The adjusted pitch parameter is given by
Adjusted_Pitch_Parameter=Pitch_Parameter−k*1200
where k represents the number of rate change intervals and may be negative/positive depending on whether the change is down/up.

If the processing load is high, the control module 16 may elect to force an early downward rate change or a late upward rate change to reduce the processing load (blocks 114-120). When forcing a downward rate change to ease processing load, the forced rate change may be applied only to the audio signal being set up, to all audio signals, or to selected audio signals. Various criteria may be applied to select the audio signals to which the forced change will be applied. For example, the forced change may be applied to all audio signals whose current rate exceeds a predetermined level, e.g., 8 kHz. Also, selected ones of the audio signals may be exempted from the rate change. For example, some audio signals may be affected more than others by loss of higher frequencies, such as percussion voices. Those audio signals for which the higher frequencies are important may be exempted.

Changing the sample rate of the output audio signal at octave intervals of the pitch parameter reduces the computational load on the processor without loss of audio content. Nevertheless, there may be some situations where the processing load becomes excessive, e.g., when a large number of audio signals or synthesizer voices need to be processed. In these situations, the control module 16 can force an early change or late change in the playback rate responsive to the current load conditions to reduce the computational load. The forced rate change can be implemented in a manner to maintain a high signal quality despite some loss in bandwidth.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of controlling processing load in an audio device comprising:
varying the sample rate of an audio signal as a function of a pitch parameter;
adjusting the pitch parameter to compensate for sample rate changes; and
pitching the audio signal by an amount determined based on the adjusted pitch parameter.

2. The method of claim 1 wherein varying the sample rate of an audio signal as a function of a pitch parameter comprises changing the sample rate at predetermined intervals of the pitch parameter.

3. The method of claim 1 wherein changing the sample rate at predetermined intervals of the pitch parameter comprises increasing or decreasing the sample rate by a factor of two at intervals of the pitch parameter corresponding to one octave.

4. The method of claim 1 wherein adjusting the pitch parameter to compensate for sample rate changes comprises adding or subtracting an amount to the pitch parameter corresponding to the change in sample rate.

5. The method of claim 1 wherein said varying, adjusting and pitching are performed independently on a plurality of audio signals.

6. The method of claim 5 further comprising:
monitoring processing load; and
varying the sample rate of one or more of said audio signals as a function of processing load.

7. The method of claim 5 wherein varying the sample rate of one or more of said audio signals as a function of processing load comprises reducing the sample rate of selected audio signals when processing load exceeds a predetermined level.

8. The method of claim 5 wherein varying the sample rate of one or more of said audio signals as a function of processing load comprises increasing the sample rate of selected audio signals when processing load falls below a predetermined level.

9. An audio processing device comprising:
a pitching module to adjust the pitch of an audio signal responsive to a pitch parameter;
a control module to control the sample rate of the pitching module responsive to the pitch parameter and to adjust the pitch parameter to compensate for changes in the sample rate.

10. The audio processing device of claim 9 wherein the control module varies the sample rate at predetermined intervals of the pitch parameter.

11. The audio processing device of claim 10 wherein the control module increases or decreases the sample rate by a factor of two at the predetermined intervals of the pitch parameter corresponding to one octave.

12. The audio processing device of claim 9 wherein the control module adds or subtracts an amount to the pitch parameter corresponding to the change in sample rate to generate an adjusted pitch parameter.

13. The audio processing device of claim 9 wherein the pitching module independently adjusts the pitch on a plurality of audio signals.

14. The audio processing device of claim 13 wherein the control module monitors processing load and varies the sample rate of one or more of said audio signals as a function of processing load.

15. The audio processing device of claim 14 wherein the control module reduces the sample rate of selected audio signals when processing load exceeds a predetermined level.

16. The audio processing device of claim 14 wherein the control module increases the sample rate of selected audio signals when processing load falls below a predetermined level.

17. A method of controlling processing load in an audio device comprising:
monitoring processing load;
varying the sample rate of an audio signal as a function of processing load; and
adjusting a pitch parameter to compensate for sample rate changes;
pitching the audio signal by an amount determined based on the adjusted pitch parameter.

18. The method of claim 17 wherein varying the sample rate of the audio signal as a function of processing load comprises reducing the sample rate when processing load exceeds a predetermined level.

19. The method of claim 17 wherein varying the sample rate of the audio signal as a function of processing load comprises increasing the sample rate when processing load drops to a predetermined level.

20. An audio processing device comprising:
a pitching module to adjust the pitch of an audio signal responsive to a pitch parameter;
a control module to control the sample rate of the pitching module responsive to processing load and to adjust the pitch parameter to compensate for changes in the sample rate.

21. The audio processing device of claim 20 wherein the control module reduces the sample rate when processing load exceeds a predetermined level.

22. The audio processing device of claim 20 wherein the control module increases the sample rate when processing load falls below a predetermined level.
